(19) United States
(12) Patent Application Publication
(10) Pub. No.: US 2006/0293975 A1
(43) Pub. Date: Dec. 28, 2006

(54) Department based shopping map/list

(76) Inventor: Magnus Hansson, Malmo (SE)

Correspondence Address: HARNESS, DICKEY & PIERCE, P.L.C., P.O. BOX 8910, RESTON, VA, 20195, US

(21) Appl. No.: 11/472,316

(22) Filed: Jun. 22, 2006

Related U.S. Application Data
(60) Provisional application No. 60/693,072, filed on Jun. 23, 2005.

(51) Int. Cl. G07F 7/00

(52) U.S. Cl. 705/27

(57) ABSTRACT

A map is disclosed. The map is configured to aid a shopper while shopping in a shop having a plurality of departments. The departments are specific to the shop. The map includes a pre-printed shop specific pattern that includes graphical containers. Each container represents a department of the shop. The containers are associated with a representative identifier and a handwriting area. A computer program and method of providing and/or generating the map are further disclosed.

### PRIORITY STATEMENT

The present application hereby claims priority under 35 U.S.C. § 119(e) on U.S. provisional patent application No. 60/693,072 filed Jun. 23, 2005, the entire contents of which is hereby incorporated herein by reference.

### TECHNICAL FIELD

The present invention relates to store specific shopping maps that can be used as shopping lists and methods for providing such shopping maps.

### BACKGROUND

Many people are regularly buying articles in grocery stores. It is common to write down a shopping list prior to visit a grocery store. The shopping list typically contains the articles and amounts to be purchased. Such list may be written on any piece of paper and the shopping list is then brought to the store.

A disadvantage with this method is that the list does not indicate in which location the articles can be found in the store. Another disadvantage is that list needs to be put away in a pocket or bag every time the shopper needs both hands e.g. to take articles from a shelf and put them in a shopping cart.

The disadvantage of the ordinary shopping list method is partly overcome by the methods and systems described in patent to Talbott, U.S. Pat. No. 6,000,610, wherein a store specific shopping system and method including a map/shopping list is disclosed. The system comprises a graphical map. A specific article is represented by its name. The location of each article is indicated by the location of its name in the map.

Typically an article's name is printed in a graphical representation of a shelf. Optionally a written index of articles is provided on the map. The map and index are pre-printed on a paper with a preferred size of 8.5×14 inches. The user can create a shopping list by marking articles indicated in the map or contained in the index. Marking is done by e.g. encircling or underlining the text representing each article.

A disadvantage with the system and method taught by Talbott is that the anticipated size of the paper is fairly large and needs to be attached to a supporting clipboard that in it's turn is mounted on to a grocery cart. The clipboard and the mounting procedure add cost to the system.

Another disadvantage is that even if several articles are represented by text in the map or in the index, such representation can only cover a fraction of the thousands of articles that are on sale in a typical store.

### SUMMARY

In view of the above it is an object of the present invention to overcome disadvantages of prior art solutions and to provide a new type of shopping map and methods for providing inexpensive or free shopping map.

According to one embodiment of the present invention a portable shopping map that can also be used as a shopping list is provided. The shopping map comprises a pre-printed shop specific pattern that comprises graphical containers each representing a department or portion of the total shop. A representative identifier and a handwriting area are associated with each graphical container. Articles to be purchased may be written and organised in the dedicated handwriting areas to facilitate easy and efficient shopping for the customer.

According to another embodiment of the present invention a portable shopping map pattern is printed on self-adhesive notes that are stacked in a pad in a similar fashion as Post-it™ ¹ notes. Each paper has a self-adhesive area on the backside that, in contrast to a Post-it™ note, is located in a lower part of the paper to improve the usability when attaching the note to a bar handle of a shopping cart.
¹ Post-it™ is a trademark of 3M Incorporated

According to yet another embodiment of the present invention a method for providing inexpensive or free shopping maps is provided. An agreement is established with a shop and the maps are created and provided. In an embodiment, funds are obtained from sponsors in return for advertising space on the shopping map. The funds are used to finance the costs associated with design, manufacturing and distribution of the shopping maps.

According to yet another embodiment of the present invention a software program is provided that aids in the graphical design of a shopping map. The software program includes functions for drawing graphical containers, each one representing a department of the shop. The software program also includes functionality for entering identifiers and handwriting areas, and associating them with the graphical containers.

It is to be noted that the term shop and store are used interchangeably throughout this description and the appended claims. The term shop or store is also to be considered as being representative of an owner of a shop or store, where the context does not specify spatial relationships such as areas or departments etc. Moreover, the term shop or store is to be interpreted to include a collection of shops or stores, such as a shopping mall, a chain of shops or stores or a dedicated shopping district covering a large geographical area. Similarly, the term shop department is also to include any designated area within a shop.

### BRIEF DESCRIPTION OF THE DRAWINGS

FIG. 1 shows prior art in form of a Post-it™ note.

FIG. 2 illustrates an example placement of the glue on a pad of self-adhesive notes

FIG. 3 shows a shopping map example print

FIG. 4 shows a flow chart that describes a method for creating customer loyalty

FIG. 5 shows how the self-adhesive note containing the department based shopping map, can be placed on a shopping cart

FIG. 6 shows a shopping map containing discount coupons

FIG. 7 shows a typical viewing angle when using the shopping map

FIG. 8 shows a flow chart that describes a software program that aids the graphical design of a store specific shopping map

FIG. 9 shows a schematic of a method for providing inexpensive or free shopping maps at little or no charge

### DETAILED DESCRIPTION OF EMBODIMENTS

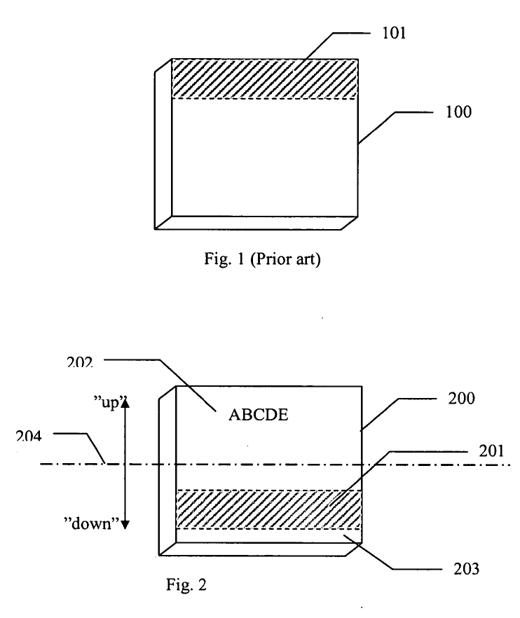

FIG. 1 illustrates prior art in form of a pad (100) of self-adhesive notes. Each note has a self-adhesive area (101) on the top part of the backside. This self-adhesive area is used to hold the notes together in the pad. It is also used when attaching a note to another surface e.g. a paper, a wall or a door.

FIG. 2 illustrates an embodiment of the present invention in form of a pad (200) of self-adhesive notes. Each note has a graphical pattern consisting of various elements e.g. text (202) making it obvious to a user what is up and what is down on the note. Furthermore, each note has a self-adhesive area (201) on the backside, which is located in the lower part of the note, as opposed to conventional notes of Post-it™ type, where the area is positioned at the very top of the backside. The advantages with this new position will be described later.

When putting a self-adhesive note in a pocket many users double folds the note along a non-visible centre line (204). By doing that the self-adhesive area (201) is protected against dust and dirt, which otherwise would ruin the stickiness of the note. When the note is brought out of the pocket and unfolded its stickiness is well preserved. To make the unfolding easier, parts of the very bottom area (203) e.g. the corners, should not be coated with the self-adhesive material when manufactured.

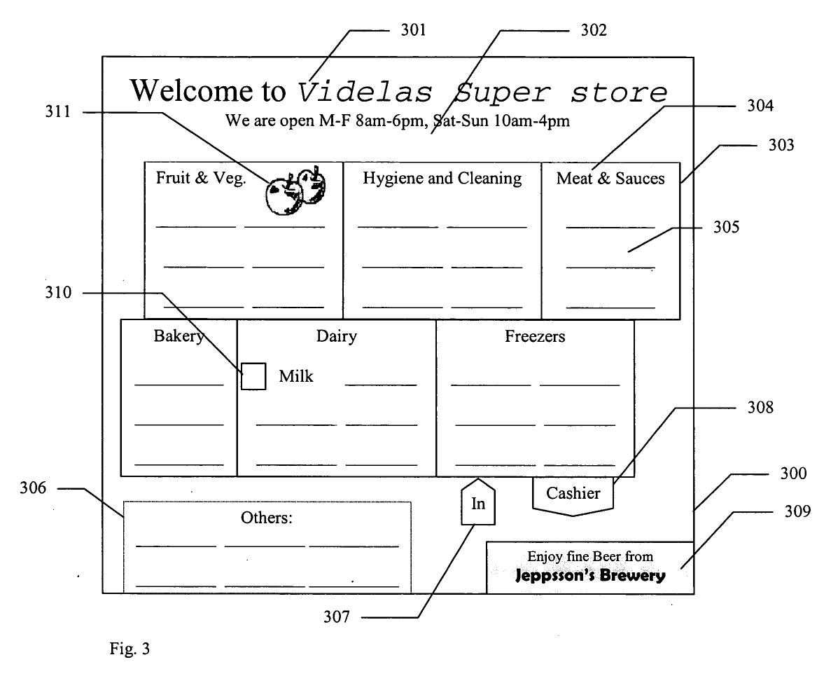

FIG. 3 illustrates another embodiment of the present invention in form of a note (300), which has a pre-printed pattern. The pre-printed pattern consists of several elements. A welcoming heading (301) includes the name of the store in form of plain text or a logotype. Underneath the heading there is information about opening hours (302). Optionally the location of the store may be included in form of a geographical map or address.

The store's physical layout is replicated by a number of graphical containers (303), which shape, relative size and position corresponds to departments or sub-areas of the store. The arrangement of the containers is unique to each store, since the store layout in most cases differs between stores. A text (304) that is representative to each department is included in each graphical container. The text can be generic words describing a department e.g. “fruits and vegetables” or it can be example articles e.g. “apple”. The graphical containers may include a picture or symbol (311) representing articles, which replaces or complements the text. Each container has an area (305) where the shopper can write down names of articles to be collected from the corresponding department in the store. Supporting lines for handwriting is included in the handwriting areas (305). Articles that are popular are represented with it's own name and a tick-box (310). The shopper can tick the box with an “x” or inserting a quantifying number.

Miscellaneous articles, for which the shopper does not know in which department they can be found, can be written in a separate container (306). This makes the shopper remember to search or ask for the location of those articles.

To ease orientation in the store the pre-printed pattern also includes symbols or text representing the entrance (307) and the exit at the cashiers (308).

The graphical pattern may include advertisements (309) e.g. for certain articles that can be found in the store. Such advertisements may consist of brands, logos or pictures of articles. Adequate advertisement material may replace or complement the text (304) and/or the symbol (311). Advertisement elements can also be complemented by a tick-box to further strengthen the marketing effect.

A typically useful size of the notes is 4×5 inches, but may vary e.g. depending on store size and wanted level of details.

When the user has written a shopping list using a shopping map as the one illustrated in FIG. 3, the shopping can be done in an efficient way since the items in the shopping list is automatically grouped together based on their location. Items that are located within the same department are grouped into the same graphical container. Thus the risk that the shopper must go back to a department that has already been visited is significantly reduced.

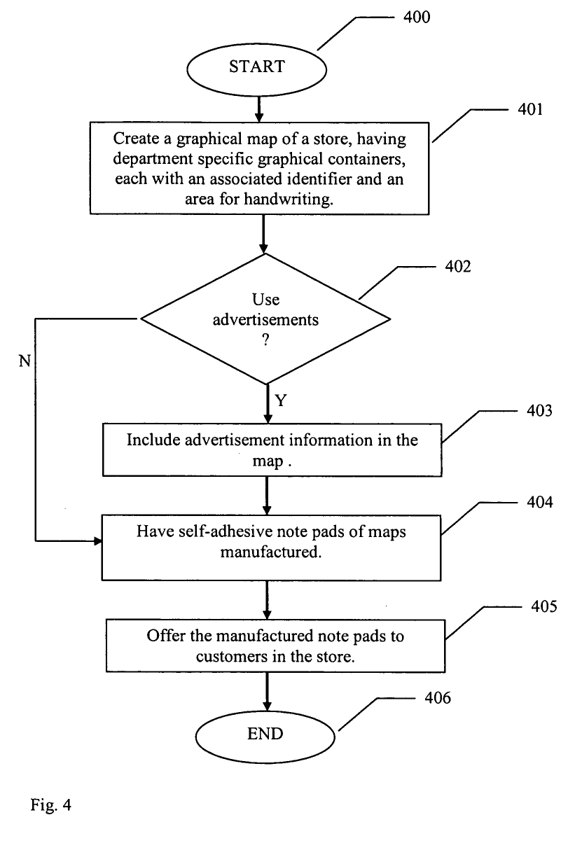

FIG. 4 illustrates yet another embodiment of the present invention in form of a flowchart, describing a business method for creating customer loyalty to a specific store. The business method commences at step 400. A graphical map of a specific store, similar to the one in FIG. 3, is created at step 401. The map contains graphical containers corresponding to departments or sub-areas of the store. Each graphical container has a department specific identifier and a handwriting area associated with it. Furthermore each graphical container has a shape and size that corresponds to the represented department or sub-area of the store. The identifier consist of text or symbols representative to the specific department or sub-area of the store.

At step 402 the method continues to step 403 if advertisement is used. If advertisement is not used the method jumps to step 404.

At step 403 advertisement paid for by other companies is added to the shopping map. So, besides creating customer loyalty, the business method may also create income from the advertisements. The shopping list is a very valuable spot for advertisement since it is in the direct view of the shopper many times during the visit to the store. Ideally the income of the advertisement may exceed the total cost associated with manufacturing and distributing the note-pads.

At step 404 self-adhesive note pads containing notes with the pre-printed shopping map, is manufactured. At step 405 the self-adhesive note pads are offered to customers visiting the store, at no or a little charge. Alternatively the note-pads may be distributed to the mailboxes of the households in the neighbourhood of the specific store.

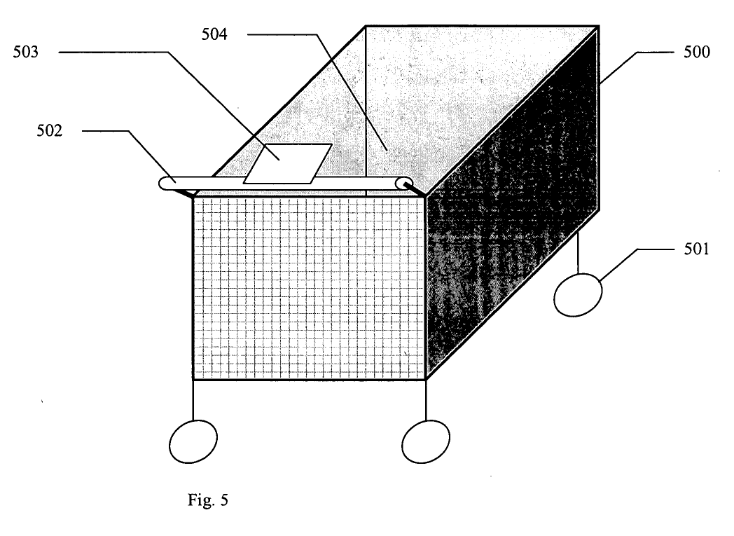

FIG. 5 illustrates yet another embodiment of the present invention in form of a shopping cart (500). The shopping cart has wheels (501), a bar handle (502) and a large compartment (504) for storing articles. When coming to the store, the shopper puts the self-adhesive note (503), containing the shopping list, on the bar handle (502) of the shopping-cart (500).

The shopper can prepare the shopping list in advance using the note-pad (200) with the pre-printed store-specific pattern illustrated in FIG. 3. The shopper writes the articles to be bought in the handwriting areas (305) of the different graphical containers (303). The shopper peels off the written paper from the notepad (200) and brings it to the store. The shopper attaches the shopping list to the bar handle (502) of the shopping cart (500). The note is fixed to the bar handle by the self-adhesive area (201) on the backside of the note. As illustrated in FIG. 5 the vast majority of note hangs in the open air over the compartment (504). This is due the low positioning of the self-adhesive area (201) as illustrated in FIG. 2. Nothing or only a minimal part of the note hangs out in the open air towards the shopper that operates the shopping cart. This significantly reduces the risk that the shopper unintentionally touches the note, causing it to fall off the bar handle (502), and possibly get lost.

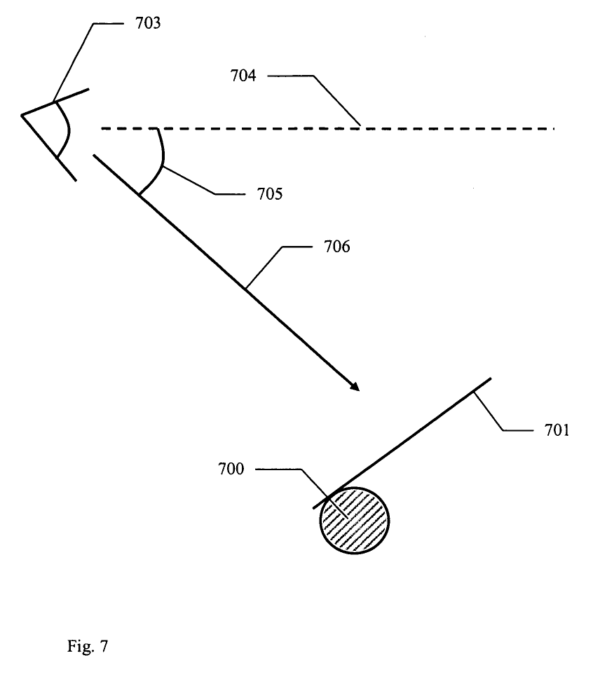

Another advantage with the low position of the self-adhesive area (201) is illustrated in FIG. 7. A note (701) is attached to the bar handle (700) of the shopping cart. A typical position of the shopper's eyes in relation to the shopping cart (700) is illustrated by the eye symbol (703). The arrow (706) and the horizontal line (704) form a viewing angle (705), which is the angle in which the shopper views the note when it is attached to the bar handle (502). A smaller angle makes it more convenient to view and read the note. The low position of the self-adhesive area (201), as illustrated in FIG. 2, forces the shopper to attach the note to the bar handle (502) in a position similar to the one illustrated in FIG. 7. This position results in a smaller viewing angle making it more convenient for the user to view and read the note. Further more this position result in a reduced risk of the shopper accidentally removing the shopping map from the bar handle (502).

When the shopper has collected all the articles, the note can easily be peeled off from the bar-handle (502) leaving virtually no trace of it ever being there.

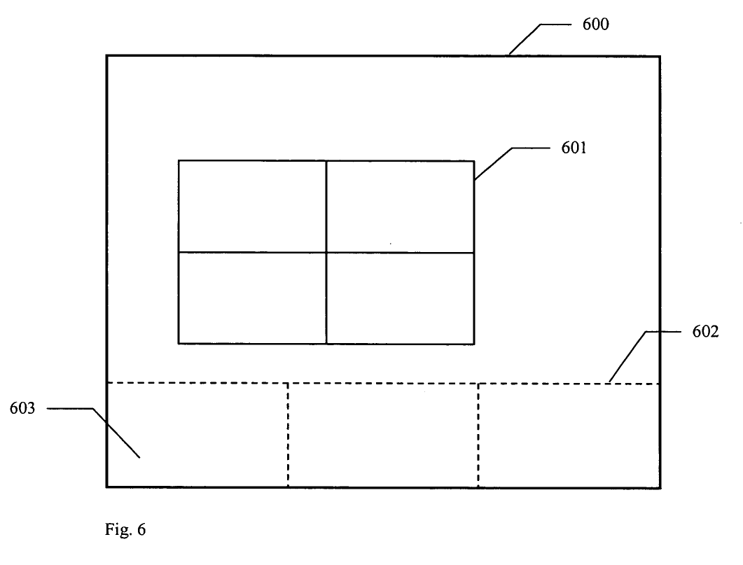

FIG. 6 illustrates yet another embodiment of the present invention in form of a self-adhesive note 600 having graphical containers (601), each one having a department specific text or symbol and an area for writing articles. The note also contains discount coupons (603) with offers valid in the specific shop. The coupons can easily be separated from the note using a scissor or by tearing along a perforated line (602).

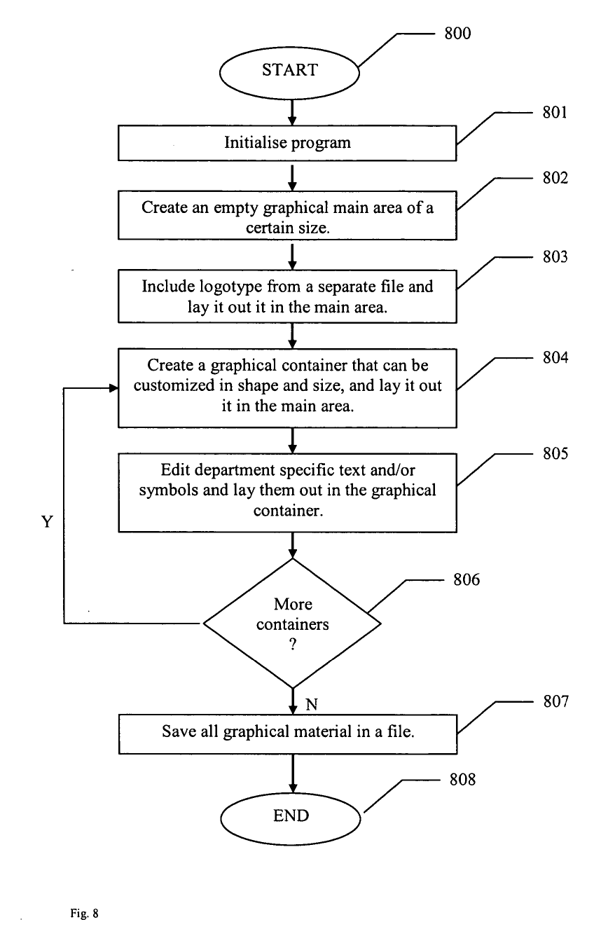

FIG. 8 illustrates yet another embodiment of the present invention in form of a flow-chart describing an example computer program commencing at step 800. The program is initialised at step 801. At step 802 an empty main area is created which corresponds to the surface of a self-adhesive note. The logotype of the store, greeting message and opening hours is edited and laid out in the main area at step 803. The logotype is typically fetched from a data file.

A graphical container is created in step 804. The container can be customised in terms of shape, size and borders. Department specific text and/or symbols is edited and laid out in the graphical container in step 805.

In step 806 the program returns to step 804 if more containers should be created. If not, the program continues to step 807 where the resulting graphical material is stored in a data file. The data file of the graphical pattern is used when printing the notes in the manufacturing process of the note-pads.

The computer program may be made available to users via the Internet. By doing that each store's representative may use the computer program to design their graphical patterns and directly order pre-printed note-pads online.

Optionally, before offered to customers, each pad is bundled with a pen and a wall-mounted holder for convenient usage at home. Both the pen and the holder may be decorated with the logo of the store.

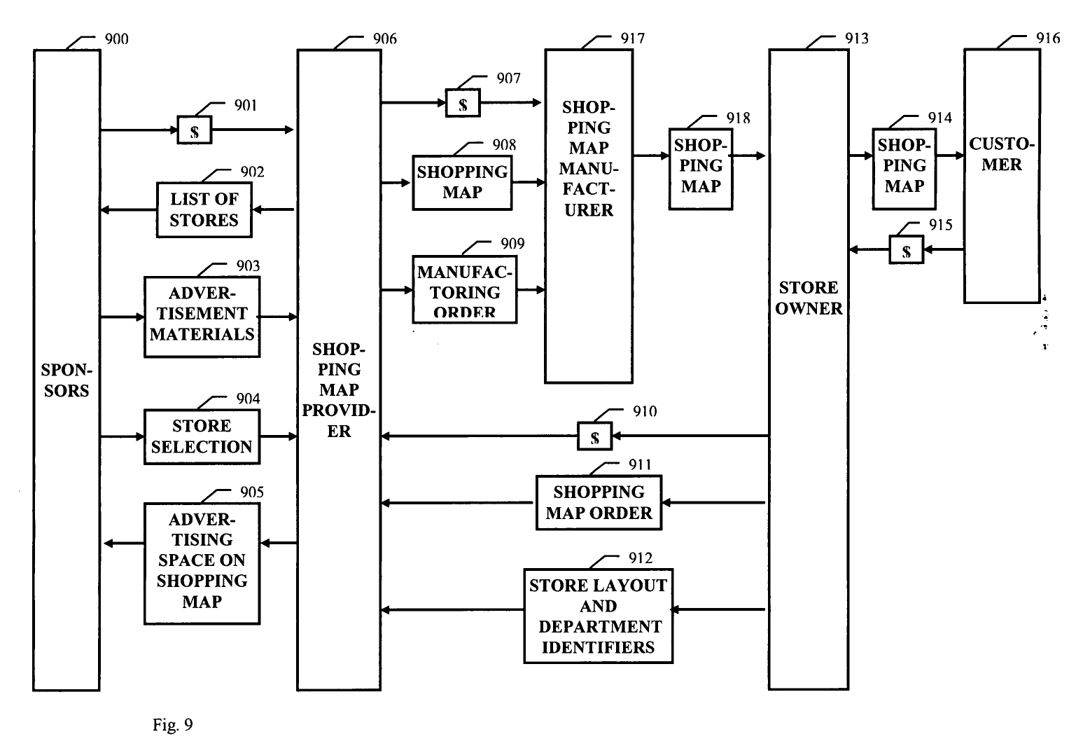

FIG. 9 illustrates yet another embodiment of the present invention in form of a schematic that describes a business method for providing inexpensive or free store specific shopping maps that can be used as shopping lists to customers.

A shop map provider (906) receives a department based store layout and department identifiers (912) from a storeowner (913). The shop map provider (906) maintains a list of all the stores that whish to obtain shopping maps. The list of stores (902) is sent to sponsors (900). The sponsors select which stores they want to purchase advertising space on shopping maps (905) for. The sponsors (900) provide the shopping map provider (906) with the store selection (904).

The shopping map provider (906) agrees with sponsors (900) and storeowners (913) on sponsoring terms and conditions for including advertisement materials (903) from the sponsors on store specific shopping maps to be used by the storeowners (913). After such commercial agreement the shopping map provider allocates advertising space on shopping maps (905) to the sponsors and the sponsor (900) provides the shopping map provider (906) with advertisement material (903) to be printed on shopping maps. The advertisement material may be a graphical representation of a product or brand. It could also contain information for discount coupons (601) to be printed on the shopping maps. In case coupons are applied the storeowner (913) may agree with the sponsors (900) to receive financial compensation when a coupon yields a discount to a customer.

The shopping map provider (906) creates a shopping map design (908) based on the store layout and department identifiers (912) received from the storeowner (913) and the advertisement material (903) received from the sponsors (900).

The storeowner places a shopping map order (911) of a certain quantity of shopping maps to the shopping map provider (906) and pays an amount (910) that may be discounted by the shopping map provider base don the funds (901) received by the sponsors (900).

The shopping map provider sends the shopping map design (908) to the shopping map manufacturer (917). Based on received shopping map orders (911) the shopping map provider (906) places manufacturing orders (909) to the shopping map manufacturer (917). The manufacturer produces the shopping maps with the pre-printed shopping map design (908) and sends the shopping maps (918) to the storeowner (913).

The storeowner (913) offers the visiting customers (916) the shopping maps (914) at a little or no charge (915). Alternatively the shop owner (913) puts the shopping maps in the mailbox of potential customers (916) living within a certain distance from the store.

It is to be understood that the storeowner (913) may own multiple stores belonging to a store chain. It is also to be understood that a storeowner (913) may solely or partly also take the role as the shopping map provider (906) interacting directly with the sponsors (900) and the shopping map manufacturer (917). Further it is to be understood that sponsoring may be left out completely in the method. This may be the case if the storeowner (913) decides so or if there are no agreements reached with any of the sponsors (900).

It is to be understood that although the invention disclosed herein is fully capable of achieving the objectives and providing the advantages described, the characteristics of the invention described herein are merely illustrative of the preferred embodiments. Accordingly, it is not intended that the scope of the invention be limited to details of the embodiments described. Equivalents, adaptations and modifications of the invention reasonably inferable from the description contained herein are included within the scope of the invention as defined by the appended claims.

1. A map configured to aid a shopper while shopping in a shop having a plurality of departments, said departments being specific to the shop, the map comprising a pre-printed shop specific pattern that comprises graphical containers, each container representing a department of the shop, said containers being associated with a representative identifier and a handwriting area.

2. The map according to claim 1, being printed on a sheet having adhesive means for attaching to a shopping cart.

3. The map according to claim 2, where the adhesive means are located on a lower part of the backside of the sheet.

4. A stack of maps according to claim 2.

5. A method for generating a map according to claim 1, comprising the steps of:
drawing graphical containers, each container representing a department of the shop,
drawing identifiers and handwriting areas, and
associating the identifiers and handwriting areas with the graphical containers.

6. A computer program on a computer readable medium, said program comprising software instructions that, when loaded into a computer, are capable of controlling the computer to perform a method according to claim 5.

7. A method for providing a shopping map according to claim 1, comprising the steps of:
establishing an agreement with at least a shop regarding provision of shopping maps,
creating the shopping maps, and
providing the shopping maps.

8. A method according to claim 7, comprising the steps of:
establishing an agreement with at least one sponsor and a shop on sponsoring terms and conditions for including advertisement materials from the sponsor on store specific shopping maps,
creating a shopping map design based on a shop layout and department identifiers received from the shop and advertisement material received from the at least one sponsor,
creating a plurality of maps based on the shopping map design, and
providing the maps to the shop.

9. A method for providing a shopping map according to claim 1, comprising the steps of:
establishing an agreement with at least one sponsor on sponsoring terms and conditions for including advertisement materials from the sponsor on store specific shopping maps,
creating a shopping map design based on a shop layout, department identifiers and advertisement material received from the at least one sponsor, and
providing the maps to shoppers.

10. A stack of maps according to claim 3.
